(19) United States
(12) Patent Application Publication
(10) Pub. No.: US 2023/0021240 A1
(43) Pub. Date: Jan. 19, 2023

(54) RELATIVE DISTANCE FROM GOLF HOLE MEASURING DEVICE

(71) Applicant: Jack Hancosky, Avoca, NY (US)

(72) Inventor: Jack Hancosky, Avoca, NY (US)

(21) Appl. No.: 17/864,178

(22) Filed: Jul. 13, 2022

Related U.S. Application Data
(60) Provisional application No. 63/221,274, filed on Jul. 13, 2021.

(51) Int. Cl. A63B 57/00; A63B 71/06

(52) U.S. Cl. CPC A63B 57/00; A63B 71/0622; A63B 2220/20

(57) ABSTRACT

A simple method for and apparatus for determining relative distance for two or more halls. The apparatus comprises two distinguishable pointers joined by a common axis that allows the pointers to rotate relative to each other. The mechanism also include means to allow the two pointers to be fixed relative to one another.

### CROSS-REFERENCE TO RELATED APPLICATIONS

This application claims priority to and is a non-provisional of U.S. Patent Application 63/221,274 (filed Jul. 13, 2021) the entirety of which is incorporated herein by reference.

### BACKGROUND OF THE INVENTION

In the game of golf an understood etiquette is followed that dictates the order of players taking shots in their group. In essence, the players whose ball is farthest from the pin shoots before the other players whose ball is closer to the pin. Hence ball position is important and knowing whose ball is furthest away is important.

Often, close to the pin, the distance can and often is determined by use of a tape measure. The use of the tape measure necessarily requires the tape to swing from the pin to the ball, each ball as it turns out, and can require time to determine, Tape use often causes damage to the cup and requires additional traffic on the green, crossing the lines of putts of other players, unnecessary compaction of the green's surface and use is limited in distance by size of reel/length of tape, and the dimensions of the green. LTR Away use is unlimited. So there exists a need for a simple mechanism to relatively compare distances and determine order of play.

The present invention provides a simple method for and apparatus for determining relative distance for two or more balls. The apparatus comprises two distinguishable pointers joined by a common axis that allows the pointers to rotate relative to each other. The mechanism also include means to allow the two pointers to be fixed relative to one another.

Each pivot point of pointers is distinguishable from the other pointer so that the user can place the pointer above their ball being played, line up the flag in the hole with the first pointer and then line up the other player's ball with the second pointer. The relative position of the first pointer and the second pointer is fixed, and the device is taken to the second ball and the first pointer is lined up with the first player's ball, and the second pointer is moved to point at the hole flag. If the angle is increased to make this alignment the second ball is closer. If the angle is decreased the ball is further away.

When two devices with incremental indicators are used simultaneously by two players, one over each of the two positions, the indicators enable communication of the relative proximity without having to travel between both positions, another contribution to an important concern, speed of play,

Attached are several photos of the device. In many instances the pointers are elongated sticks with sites attached at either end to allow for more precise sighting. However, shorter pointers are useable, and can be formed into kit forms that as shown in FIG. 1 are two pointers, a carrying case in tube form, a rotatable cap, the carrying case has a fixed means to hold the detachable first point, and the rotatable cap detachably holds the second pointer.

Where balls are on opposite sides of the hole, each player can place a club one length from their ball and the other player can measure from the ball to the end of the club length with the device.

### BRIEF DESCRIPTION OF THE DRAWINGS

FIGS. 1, 2, 3, 4, and 5 show simpler apparatus that can be used to practice the nearest ball determination method outlined above.

FIG. 1 shows a form of the apparatus of the invention with an internal pivot that connects two pointers. The device is compact and can fit in a golf bag. Optionally the device can also include a holder that keeps the pointers together while being stored. The device as shown could also have a set of markings on the lower ring that allows the pointers to be rotated, thus providing a relative measure of angle.

FIG. 2 shows a form of the device with a tube, a cap and two pointers. The cap can be rotated to allow relative measurement of the angle between the two balls and the flag. Additionally, the two pointers can be removed from holders in the cap and tube, and they can be stored in the tube and the cap placed on.

FIG. 3 shows the components of the assembled device of FIG. 2.

FIG. 4 shows yet another version of the device comprising a carrying tube that is configured to be a pointer, a pivot affixed to said tube attaching to a second pointer, and a graduated extension from said tube that can be opened to an affixed position. This embodiment also allows for a compact stored form that is easy to use and easy to store.

FIG. 5 shows another embodiment where a storage tube acts also as a pointer, the second pointer is attached to the tube by a pivot and is also attached to a sliding gradient measure.

FIG. 6 shows an embodiment of the invention where the two pointing arms can be removed from a central body and stored inside the body.

FIG. 7 shows a planar version of the device with two sighting arms, an angle indicator, and a vertical sight 201 for placing the device on a vertical axis above a golf ball.

FIG. 8 shows the apparatus of FIG. 7 with the sighting arms spread apart to an angle showing the relative angle between the other player's golf ball and the golf hole.

### DETAILED DESCRIPTION OF THE INVENTION AND METHOD

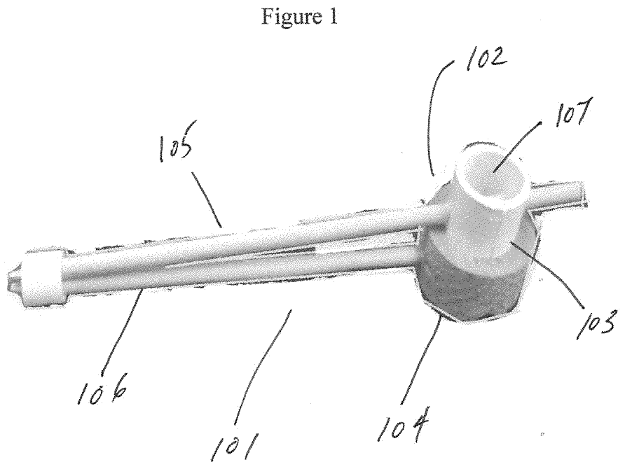

In FIG. 1 a simple version of the claimed device 101 is shown that has a central pivot body 102, which has a first part 103 and a second part 104 part allows the first sighting arm 105 to be inserted or held, and the second part allows the second sighting arm 106 to be inserted therein. The pivot body 102 has a central hollow portion 107 in the embodiment that is held above a golf ball to determine a vertical axis.

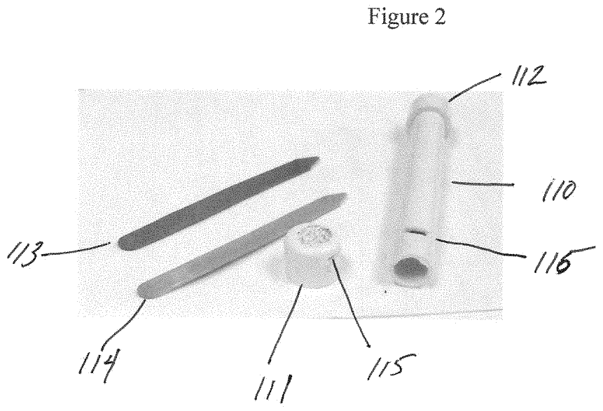

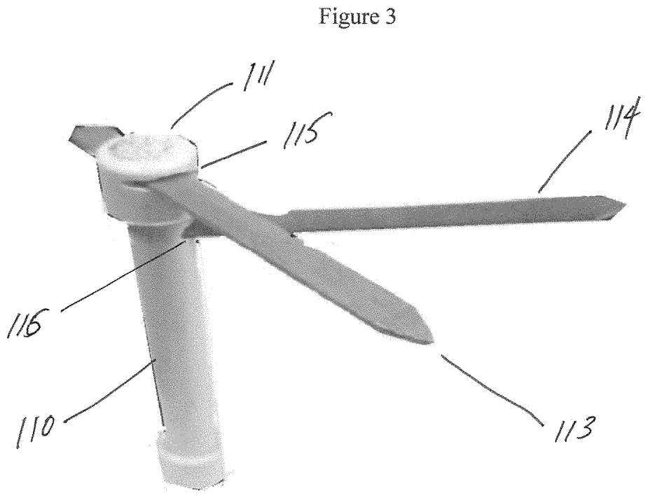

In FIGS. 2 and 3 a simple to carry device is shown where the first and second sighting arms are carried in a small tube 110 with a slotted cap 111 and a fixed cap 112 that are removably affixable to said tube. A first and a second sighting arms 113, 114 are provided and are insertable into a slot 115 in slotted cap and a slot 116 121 the small tube. The sighting arms are deployed when needed to measure relative angle according to the method described. In one form of the device with no specific angle measurement scale the device is used at a first golf ball, the arms are deployed to point to the golf hole flag and the other ball, and then the device is walked to the second ball to see whether the angle between opposing golf ball and golf flag is greater or less. However an angle indication can be affixed to the top of the slotted cap which will indicate the relative angle in another form. If the angle is less than the deployed arms, then the second ball is second ball is farther away. This embodiment also allows for a compact stored form that is easy to use and easy to store.

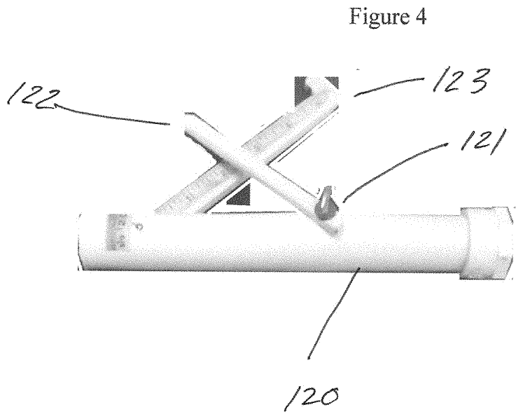

FIG. 4 shows yet another version of the device comprising a sighting tube 120 configured to be a pointer and sighted with the inner cavity of the tube. A pivot 121 affixed to said tube attached to a pointer 122 acts as the second pointer. a second graduated extension 123 from said tube provides a relative measurement of the angle

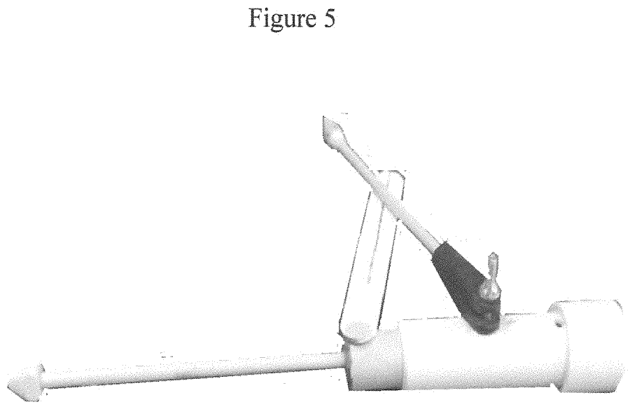

In FIG. 5 another embodiment of the invention the uses a tube tube for a pointer as a second pointer. The first pointer is stored in the storage device and when the device is employs the sighting arm is taken out and the arm affixed to a pivot on the storage tube body. The sighting arm is swung from said pivot to align with the other players gold ball after the hollow storage tube is sighted to the golf hole.

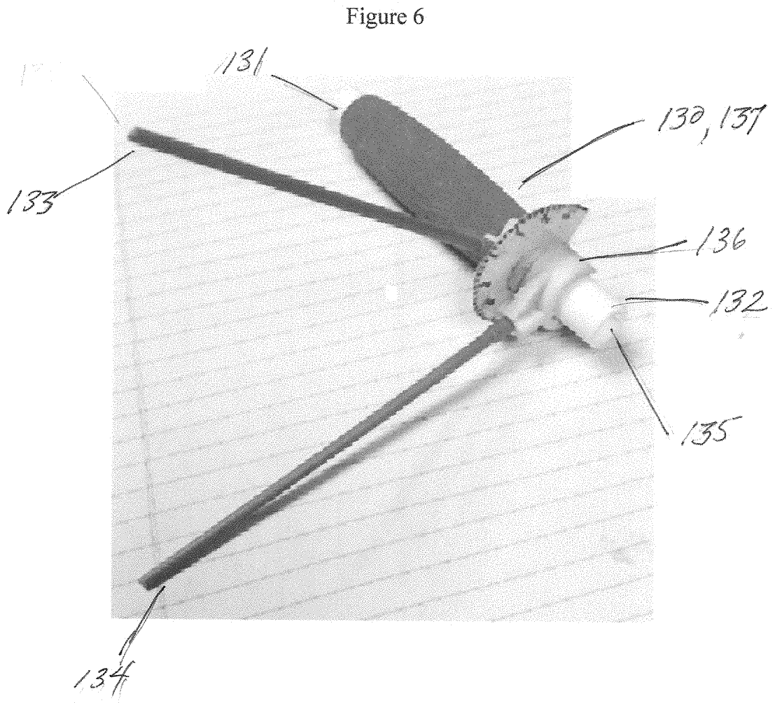

In FIG. 6 Shows a further embodiment with end caps that can be removed so the body is in the form of a tube 130 with a first open end 131 and a second open end 132. This body can then be used to sight the ball of the player from a vertical direction ensuring the device is over the ball. The two arms 133, 134 are placed in separate rotatable holes of the body, that has two rotatable portions 136, 137 . The rotatable portions each have a cavity 135 that an arm can be inserted into and then the first arm is sighted to the golf hole, and the second arm is sighted to the other players golf ball. The device can then be taken above the second player's ball, and the relative angle can then be measured as either greater or less than the angle measured above the first player's ball.

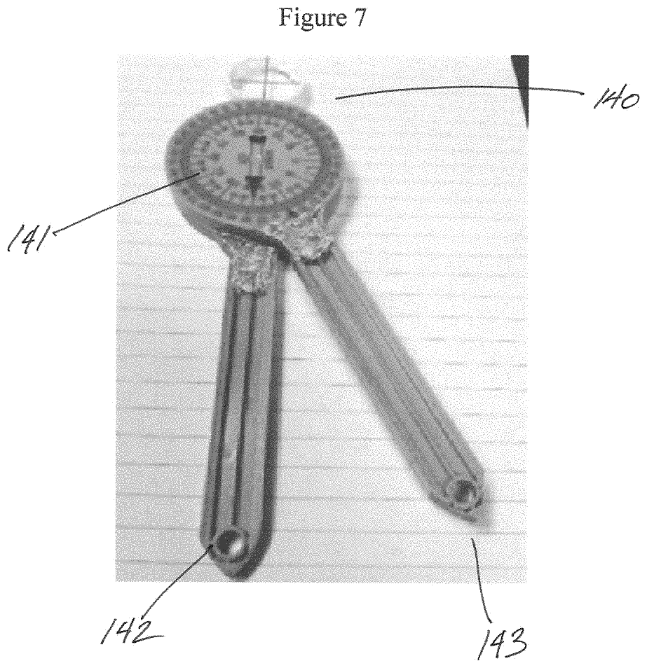

FIG. 7 shows a planar version of the device with two sighting arms, an angle indicator, and a vertical sight 140 for placing the device on a vertical axis above a golf ball. The device farther has a pivot 141 for said first arm 142 and said second arm 143 where said pivot has angle indicators.

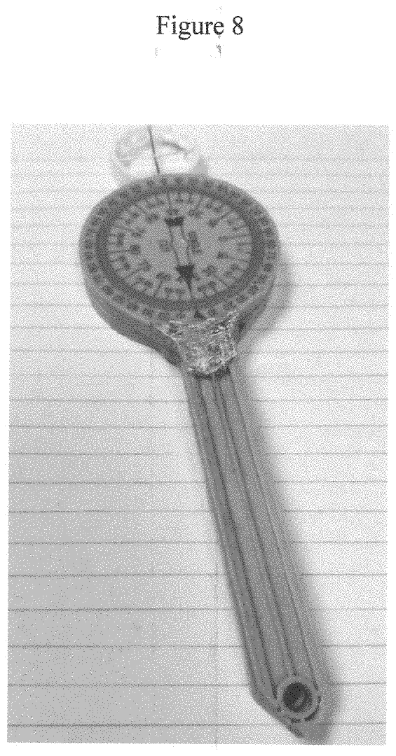

FIG. 8 shows the apparatus of FIG. 7 with the sighting arms spread apart to an angle showing the relative angle between the other player's golf ball and the golf hole. An apparatus to be used in a method for measuring the relative distance of at least two golf balls from a gold hole in order to determine proper order of play comprising: a central at least two part pivotable circular body with at least two sighting arms insert indentations; a first insertable sighting arm; a second insertable sighting arm; wherein said pivot body has a first body part that cooperates with a second body part to be rotatable with said first body part and wherein said pivot body has a hollow portion which can be used to locate the apparatus vertically above a golf ball on a vertical plane.

The apparatus may further comprises an angle measurement indicator perpendicular to said vertical plane where said angle measurement indicator measures the angle between said first sighting arm and said second sighting arm. Alternately the pivot body further comprises a first endcap and a second endcap so that said first endcap and said second endcap can be inserted into the pivot body to form a storage space for said first sighting arm and said second sighting arm.

What is claimed is:

1. An apparatus to be used in a method for measuring the relative distance of at least two golf balls from a gold hole in order to determine proper order of play comprising:
A central at least two part pivotable circular body with at least two sighting arms insert indentations;
A first insertable sighting arm;
A second insertable sighting arm;
Wherein said pivot body has a first body part that cooperates with a second body part to be rotatable with said first body part and wherein said pivot body has a hollow portion which can be used to locate the apparatus vertically above a golf ball on a vertical plane.

2. The apparatus of claim 1 which further comprises an angle measurement indicator perpendicular to said vertical plane where said angle measurement indicator measures the angle between said first sighting arm and said second sighting arm.

3. The apparatus of claim 1 wherein said pivot body further comprises a first endcap and a second endcap so that said first endcap and said second endcap can be inserted into the pivot body to form a storage space for said first sighting arm and said second sighting arm.
